(19) United States
(12) Patent Application Publication
(10) Pub. No.: US 2024/0329966 A1
(43) Pub. Date: Oct. 3, 2024

(54) CONFIGURING A NETWORK FUNCTION SOFTWARE VERSION

(71) Applicant: Lenovo (Singapore) Pte. Ltd., New Tech Park (SG)

(72) Inventors: Ishan Vaishnavi, München (DE); Dimitrios Karampatsis, Ruislip (GB); Genadi Velev, Darmstadt (DE)

(21) Appl. No.: 18/293,110

(22) PCT Filed: Jul. 27, 2022
(86) PCT No.: PCT/IB2022/056961

§ 371 Date: Jan. 29, 2024

Related U.S. Application Data
(60) Provisional application No. 63/226,391, filed on Jul. 28, 2021.

(51) Int. Cl. G06F 8/65; G06F 9/445; G06F 11/34

(52) U.S. Cl. CPC G06F 8/65; G06F 9/44505; G06F 11/3428; G06F 2201/865

(57) ABSTRACT

Apparatuses, methods, and systems are disclosed for configuring a network function software version. One method includes receiving, at a network device, a new NF software version. The method includes determining an incorporation plan for the new NF software version. The method includes configuring the new NF software version based on a step of the incorporation plan to use the new NF software version to handle a portion of cases previously handled by an old NF software version.

### CROSS-REFERENCE TO RELATED APPLICATIONS

This application claims priority to U.S. Patent Application Ser. No. 63/226,391 entitled “APPARATUSES, METHODS, AND SYSTEMS FOR A NOVEL CODEBOOK FOR NF INSTALLATION-BASED DEPLOYMENT TESTING FOR NEW NFS” and filed on Jul. 28, 2021 for Ishan Vaishnavi et al., which is incorporated herein by reference in its entirety.

### FIELD

The subject matter disclosed herein relates generally to wireless communications and more particularly relates to configuring a network function software version.

### BACKGROUND

In certain wireless communications networks, a new network function software version may be developed. In such networks, the new network function software version may need to be deployed.

### BRIEF SUMMARY

Methods for configuring a network function software version are disclosed. Apparatuses and systems also perform the functions of the methods. One embodiment of a method includes receiving, at a network device, a new NF software version. In some embodiments, the method includes determining an incorporation plan for the new NF software version. In certain embodiments, the method includes configuring the new NF software version based on a step of the incorporation plan to use the new NF software version to handle a portion of cases previously handled by an old NF software version.

One apparatus for configuring a network function software version includes a receiver to receive a new NF software version. In certain embodiments, the apparatus includes a processor to: determine an incorporation plan for the new NF software version; and configure the new NF software version based on a step of the incorporation plan to use the new NF software version to handle a portion of cases previously handled by an old NF software version.

Another embodiment of a method for configuring a network function software version includes transmitting, from a network device, information indicating availability of a new NF software version. An incorporation plan is determined for the new NF software version, and the new NF software version is configured based on a step of the incorporation plan to use the new NF software version to handle a portion of cases previously handled by an old NF software version.

Another apparatus for configuring a network function software version includes a transmitter to transmit information indicating availability of a new NF software version. An incorporation plan is determined for the new NF software version, and the new NF software version is configured based on a step of the incorporation plan to use the new NF software version to handle a portion of cases previously handled by an old NF software version.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring a network function software version:

FIG. 2 is a schematic block diagram illustrating one embodiment of an apparatus that may be used for configuring a network function software version:

FIG. 3 is a schematic block diagram illustrating one embodiment of an apparatus that may be used for configuring a network function software version:

FIG. 4 is a schematic block diagram illustrating one embodiment of a system for configuring a network function software version:

FIG. 5 is a flow chart diagram illustrating one embodiment of a method for configuring a network function software version; and

FIG. 6 is a flow chart diagram illustrating another embodiment of a method for configuring a network function software version.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment.” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

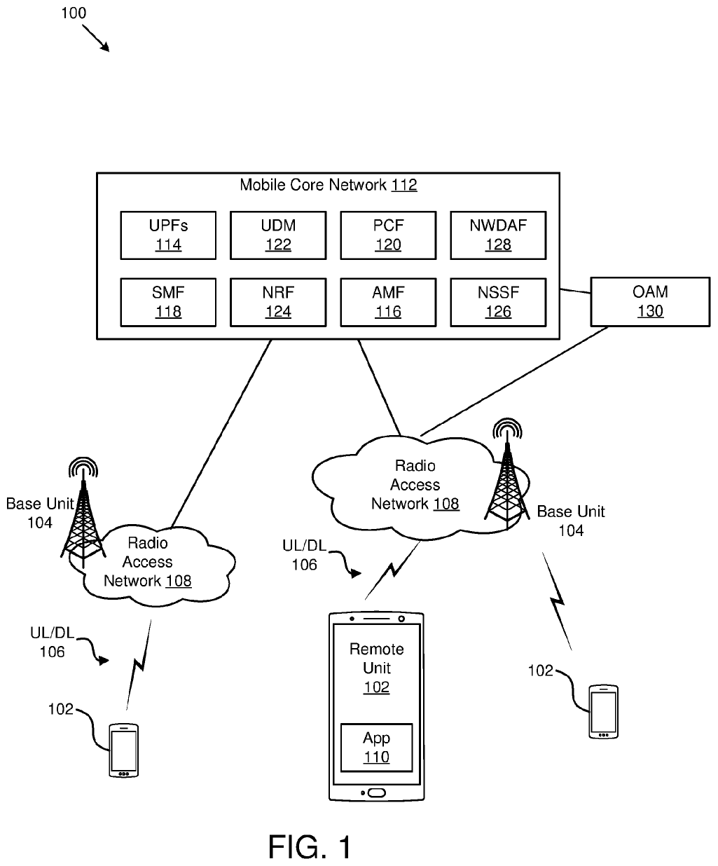

FIG. 1 depicts an embodiment of a wireless communication system 100 for configuring a network function software version.

In one embodiment, the wireless communication system 100 includes remote units 102 and network units 104 (e.g., base units). Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted display's, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL and/or DL communication signals 106. In certain embodiments, the remote units 102 may communicate directly with other remote units 102 via sidelink communication. The remote units 102 may include one or more software applications 110.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), a session management function (“SMF”), a user plane function (“UPF”), an application function, an authentication server function (“AUSF”), security anchor functionality (“SEAF”), trusted non-3GPP gateway function (“TNGF”), a network function, a digital twin creation service producer, a testing management service producer, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols, 5G Core, 5G Management and 5G Applications standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth R, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

The network units 104 may be part of a radio access network 108. Moreover, the radio access network 108 may communicate with a mobile core network 112. Further, the mobile core network 112 may include one or more network functions, such as UPFs 114, an AMF 116, an SMB 118, a PCT 120, a UDM 122, a network repository function (“NRF”) 124, an NSSF 126, and a network data analytics function (“NWDAF”) 128. The mobile core network 112 and/or the radio access network 108 are managed by the operations and management system (“OAM”) 130.

In various embodiments, a network unit 104 may receive a new NF software version. In some embodiments, the network unit 104 may determine an incorporation plan for the new NF software version. In certain embodiments, the network unit 104 may configure the new NF software version based on a step of the incorporation plan to use the new NF software version to handle a portion of cases previously handled by an old NF software version. Accordingly, the network unit 104 may be used for configuring a network function software version.

In certain embodiments, a network unit 104 may transmit information indicating availability of a new NF software version. An incorporation plan is determined for the new NF software version, and the new NF software version is configured based on a step of the incorporation plan to use the new NF software version to handle a portion of cases previously handled by an old NF software version. Accordingly, the network unit 104 may be used for configuring a network function software version.

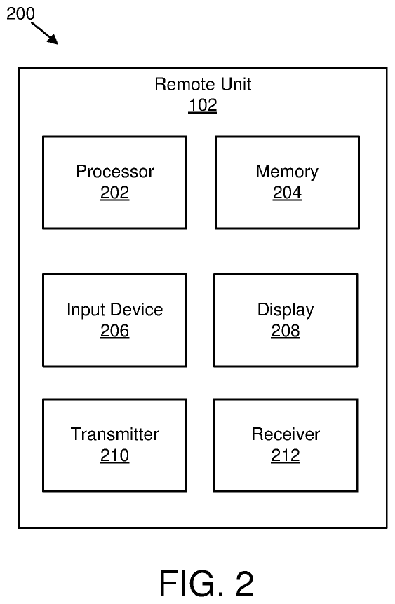

FIG. 2 depicts one embodiment of an apparatus 200 that may be used for configuring a network function software version. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

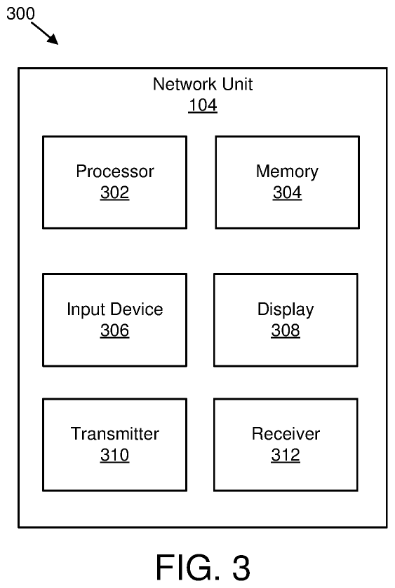

FIG. 3 depicts one embodiment of an apparatus 300 that may be used for configuring a network function software version. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312 to receive a new NF software version. In some embodiments, the processor 302 to: determine an incorporation plan for the new NF software version; and configure the new NF software version based on a step of the incorporation plan to use the new NF software version to handle a portion of cases previously handled by an old NF software version.

In some embodiments, the transmitter 310 to transmit information indicating availability of a new NF software version. An incorporation plan is determined for the new NF software version, and the new NF software version is configured based on a step of the incorporation plan to use the new NF software version to handle a portion of cases previously handled by an old NF software version.

It should be noted that one or more embodiments described herein may be combined into a single embodiment.

In certain embodiments, if a new network function (“NF”) is delivered to a continuous integration continuous delivery (“CI-CD”) system, the NF may be tested before deployment into a telecom network. However, even after testing unforeseen situations not captured in testing, the NF instance may cause an issue with a software running in deployment.

In some embodiments, a telecom network is increasingly software based. In such embodiments, a fifth generation (“5G”) architecture, particularly in a 5G control plane, is made up of virtualized software entities called NFs that can regularly be updated. In various embodiments, CI-CD pipelines are used. Once a new version of the NF is delivered to the pipeline by a vendor, an operator my perform some initial testing until the NF exists in the deployment repository. However, not all day to day situations can be captured by testing and newer NFs may still be prone to unforeseen issues. In various configurations, there is no automated way for an operator to roll out a new NF into deployment other than a complete manual update.

In certain embodiments, a new NF update in a telecom system may cause significant downtime as the update procedure is manual. Moreover, after the update there is no way for the operator to be confident that the update is error proof. In some embodiments, a CI-CD solves this problem to some extent as the new software automatically goes through a series of tests prior to deployment that minimize a risk of errors.

In various embodiments, if a new NF is instantiated, the NF registers with one or more network repository functions (“NRFs”). For example, a new SMF NF may register with an NRF serving at least the network slices which the SMF NF is configured to serve. If registering with the NRF, the NF may provide at least one of the following parameters: NF type (e.g. SMF), NF instance identifier (“ID”), fully qualified domain name (“FQDN”) or internet protocol (“IP”) address of the NF, names of supported NF services (e.g., if applicable), ranges of subscription permanent identifiers (“SUPIs”) (or ranges of generic public subscription identifiers (“GPSIs”), range(s) of external group identifiers), Range(s) of (UE) IPv4 addresses or Range(s) of (UE) IPv6 prefixes, single (“S”) network slice selection assistant information (“NSSAI”) (“S-NSSAI”) and the associated network slice instance (“NSI”) identifiers (“IDs”), dual distributed networks (“DDNs”) served by the NF, NF capacity information, NF priority information, and so forth.

In certain embodiments, a consumer NF (e.g., NF which consumes the NRF service for NF discovery) may request and may subscribe to obtain available NFs of a certain type and/or with certain criteria (e.g., serving a specific S-NSSAI or DNN). The NRF may provide to the NF consumer at least one of the following parameters: 1) a list of NF instances: 2) a validity period for a discovery result: 3) per NF instance information: NF type, NF instance ID, FQDN or IP addresses of the NF instance and, if applicable, a list of services instances where each service instance has a service name, a NF service instance ID, and optionally endpoint addresses: 4) combinations of the S-NSSAI and DNN served by the NF; and/or 5) other per NF instance information: NF load information, NF capacity information, NF priority information, and so forth. In some embodiments, a consumer NF uses provided parameters when selecting an appropriate NF.

In various configurations, there may be two different cases (e.g., embodiments) for NF delivery. In a first case (e.g., case 1), a new NF may be delivered with no prior version. In a second case (e.g., case 2), an NF update may be delivered to replace a previous version.

For the second case, if a new NF is delivered to a software repository from where it can be used for deployment by a 3GPP management system, the 3GPP management system may need to roll it out into operations. In certain embodiments, an NF deployment testing management service producer (“NFDTMSP”) may configure other NFs, such as the NRF, with an NF selection policy that determines how often the new NF is selected. The performance of the new NF is monitored and, if the performance is good, the NF selection policy in other NFs is changed so that the new version of the NF is selected more frequently than the old NF version. The process continues until the old NF is no longer selected at which point it may be phased out. Any worsening of performance or errors may result in increasingly reassigning a higher selection probability for the old NF until the new NF is no longer used.

In one embodiment, the following steps may be performed: 1) an NFDTMSP is notified of a new version or versions of a NF: 2) the NFDTMSP may be configured or already know an update plan-if none is specified, the NFDTMSP issues a notification that the update plan for a given NF is missing and may resort to using a default update plan: 3) if the plan is available, instantiate appropriate number of instances of the NF−the number of instances is determined by a number of times the NF is expected to be selected (e.g., which in turn is determined by the plan); 4) after instantiation, request the other selection-NF instances that can directly select the older version of the NF (a key component is the NRF): 5) configure those selection-NFs according to the plan so that they now select a new instance of the NF with a probability or under a set of conditions determined by the plan; and 6) check performance of the new NF: a) if performance is good, configure selection policies to increase selection until the old NF version can no longer be selected and delete the old NF version and provide an NF update notification; and b) if performance is bad or errors are reported, configure selection policies in other NFs until the new NF can be deleted and provide a notification that the new NF is not usable.

In certain embodiments, such as for case 1, the operator receives multiple versions of a new NF (e.g., from different vendors). In one embodiment, a procedure may be used until the best performing set of one or more NFs is selected. The selection between an old and a new NF may be replaced by a selection between multiple versions of the same NF. The other NF versions may then be removed.

In some embodiments, an update plan or an update policy may provide a path used to stepwise increase selection of a new NF with respect to an old one. For example, the new NF may provide, to an NRF, NF capacity information which may be increased according to the update plan. In one particular example of an NWDAF, the NRF may store the NWDAF NF with associated served analytics and NF capacity information. If a consumer NF (e.g., and AMF) triggers an NWDAF selection procedure, the NRF may provide the NF capacity information of the new version of the NWDAF. Alternatively, the NRF may be registered with a selection probability of individual NWDAF instances according to the update plan described in an example found herein. If a consumer NF (e.g., and AMF) triggers an NWDAF selection procedure, the NRF may either provide the instances of NWDAF according to a probability or may provide all instances of the NWDAF with their respective selection probabilities. The consumer NF may then choose according to the given probability distribution. In addition, the update policy and/or plan may define conditional checks under which the update may start, proceed to the next step or be withdrawn. An example of an update plan on a per slice instance basis is shown in Table 1.

TABLE 1

| NF | | Replacement | |
|---|---|---|---|
| ID | Replacement step | condition | Cancel when |
| ID123 | 1. Selection | New NF Version | Error |
| vs new | probability 10% for | available | |
| NF | new NF 90% for | | |
| | ID123 | | |
| | 2. Selection | Replacement step 1 | Error or |
| | probability 40% for | performance within | Performance still |
| | new NF (all tracking | 10% or better for 5 | below 10% after |
| | areas x1-x10), | weeks | 3 days for more |
| | 60% for old NF | | than a day |
| | 3. All Tracking Areas | After replacement | Error or |
| | x1-x90 assigned to | group 2 | Performance still |
| | new NF in addition | performance within | below 10% after |
| | to 90% selection | 10% or better for 6 | 3 days for more |
| | probability | weeks | than a day |
| | 4. NF ID123 never | After replacement | Error or |
| | selected - delete old | group 3 | Performance still |
| | slice ID | performance within | below 10% after |
| | | 10% or better for 3 | 3 days for more |
| | | weeks | than a day |

Specifically, Table 1 provides an example of what a replacement plan (e.g., incorporation plan) could look like. In Table 1, the replacement plan happens in 4 steps. If the condition (e.g., new NF version) is met, 10% of all NF lookup requests are handed over to the new version of the NF. If the performance is stable and within 10% below the performance of the NF ID123 or better for 5 weeks, then further 40% plus all requests corresponding to particular tracking areas are assigned to the new NF. The process continues further until all requests have been assigned to the new NF version. On the other hand, any errors or a performance lower than 10% after the first 3 days at any point in time triggers a replacement cancellation. This information helps automate the NF deployment process. In some embodiments, there may be default update plans or policies that are used when plans or policies for the NF are missing. The incorporation plan may depend on the other NFs that select the new NF and may be different for different other NFs.

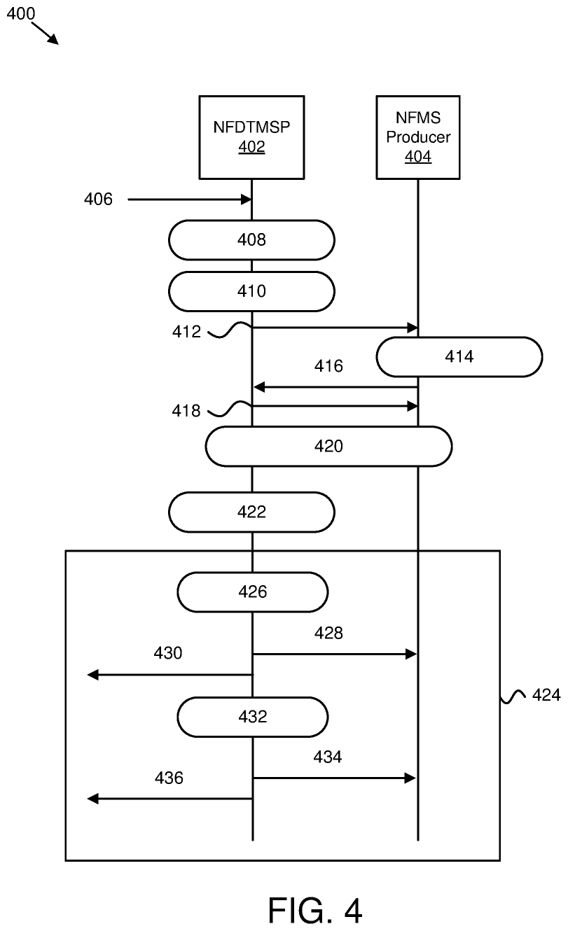

FIG. 4 is a schematic block diagram illustrating one embodiment of a system 400 for configuring a network function software version. The system 400 includes an NFDTSMP 402 and an NFMS producer 404. Each of the illustrated communications may include one or more transmitted messages.

In a first communication 406, the NFDTMSP 402 receives a notification of a new NF version (e.g., new NF available).

The NFDTMSP 402 may decide 408 if the new NF version needs to be incorporated.

The NFDTMSP 402 fetches 410 an incorporation plan for the new NF version.

In a second communication 412, the NFDTSMP 402 allocates the new NF version to the NFMS producer 404.

The NFMS producer 404 performs 414 an NF allocation of the new NF version.

In a third communication 416, the NFMS producer 404 transmits information indicating the new NF version allocation to the NFDTSMP 402.

In a fourth communication 418, the NFs are configured to select the new NF version according to the incorporation plan.

In a first example, an NF instance that is being replaced (e.g., SMF) may provide NF capacity information and NF priority information to the NRF if registering with the NRF. In some embodiments, the new NF instance (e.g., the NF instance to be tested) may provide a low capacity (e.g., able to serve 20 subscribers) in the beginning according to the incorporation plan. This NF capacity information may be provided to the NF consumer of the NRF services (e.g., AMF). Then the NF consumer may select the new NF instance (e.g., SMF) only for a few subscribers. After a while, according to the incorporation plan, the new NF instance (e.g., SMF) may increase its capacity (e.g., to 100 subscribers). The increased NF capacity may be sent to the NF consumer (e.g., AMF) and the NF consumer may select the new NF instance more frequently.

In a second example, each NF is configured with a selection probability distribution which it provides to the NRF as a part of the NF registration to the NRF, or the NF (e.g., NRF) is configured with a selection probability of a set of NFs. In various embodiments, there may be three possibilities: 1) configure the NF (e.g., SMF in the first example) that is being replaced with a probability distribution of its selection: 2) configure the intermediate node (e.g., NRF in the first example) with the selection probability; and 3) configure the consuming NF (e.g., AMF in the first example) with the selection probability.

In a fifth communication 420, normal performance monitoring procedures for the new NF are performed and additional key performance indicators (“KPIs”) for the new NF may be configured.

The NFDTMSP 402 determines 422 whether performance of the new NF version is satisfactory. The performance of the new NF version is compared with that of the old version of NF and if performance is satisfactory 424 and the condition for the next step in the incorporation plan is met then the NFDTMSP 402 repeat 426 steps 418 through 422 with the new step from the incorporation plan each time until the old NF version can no longer be selected.

In a sixth communication 428, if the old NF version can no longer be selected and is not being used, the old NF version is removed.

In a seventh communication 430, if required, the NFDTMSP 402 may issue a notification of old NF version removal and new NF version usage.

If performance in not satisfactory or an error notification is received, then the NFDTMSP 402 repeats 432 steps 418 through 422 with rolling back the steps until the new NF version has no further possibility of selection and is not being used.

In an eighth communication 434, if the new NF version can no longer be selected and is not being used, the NFDTMSP 402 initiates removing the new NF version.

In a ninth communication 436, the NFDTMSP 402 may issue a notification and log the new NF version not usable. It should be noted that the NFDTMSP 402 may be collocated with the NFMS producer 404.

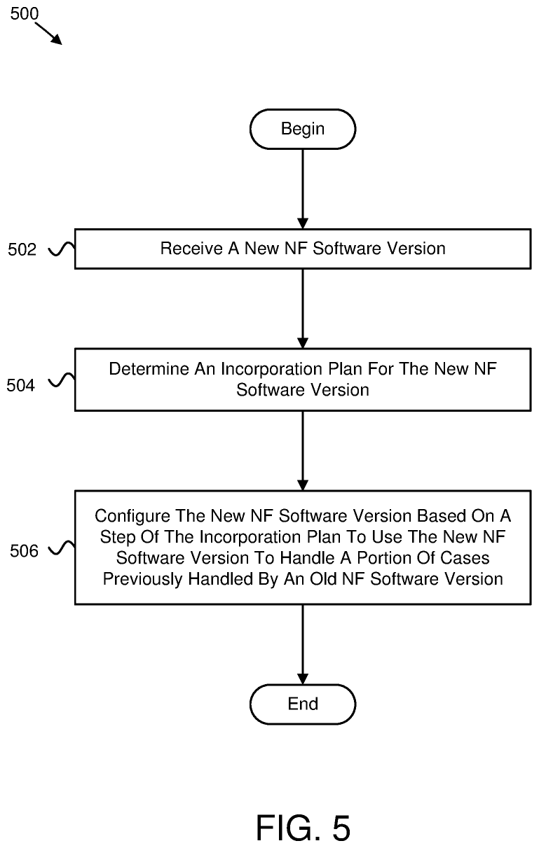

FIG. 5 is a flow chart diagram illustrating one embodiment of a method 500 for configuring a network function software version. In some embodiments, the method 500 is performed by an apparatus, such as the network unit 104. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes receiving 502, at a network device, a new NF software version. In some embodiments, the method 500 includes determining 504 an incorporation plan for the new NF software version. In certain embodiments, the method 500 includes configuring 506 the new NF software version based on a step of the incorporation plan to use the new NF software version to handle a portion of cases previously handled by an old NF software version.

In certain embodiments, the method 500 further comprises: comparing operation of the new NF software version to a predetermined performance criterion; and in response to the new NF software version meeting the predetermined performance criterion, increasing or decreasing usage of the new NF software version based on a next step or a previous step of the incorporation plan. In some embodiments, increasing usage of the new NF software version based on the next step of the incorporation plan comprises incrementally increasing usage of the new NF software version until an old NF software version is no longer used. In some embodiments, the method 500 further comprises, in response to the old NF software version no longer being used, initiating removal of the old NF software version.

In one embodiment, the method 500 further comprises, in response to the new NF software version meeting a predetermined underperformance criterion, decreasing usage of the new NF software version based on the previous step of the incorporation plan. In certain embodiments, decreasing usage of the new NF software version based on the previous step of the incorporation plan comprises incrementally decreasing usage of the new NF software version until the new NF software version is no longer used. In some embodiments, the method 500 further comprises monitoring operation of the new NF software version and monitoring operation of the old NF software version.

In some embodiments, the predetermined performance criterion comprises a comparison of operation of the new NF software version to operation of the old NF software version. In one embodiment, the portion of cases comprises UEs assigned to the new NF software version, subscription requests, service requests, notification requests, requests for any functionalities the NF may provide, or some combination thereof.

In certain embodiments, the cases or UEs are assigned to the new NF software version based on a location, a parameter, a characteristic, an event, a predetermined condition or some combination thereof. In some embodiments, the method 500 further comprises determining whether to incorporate the new NF software version.

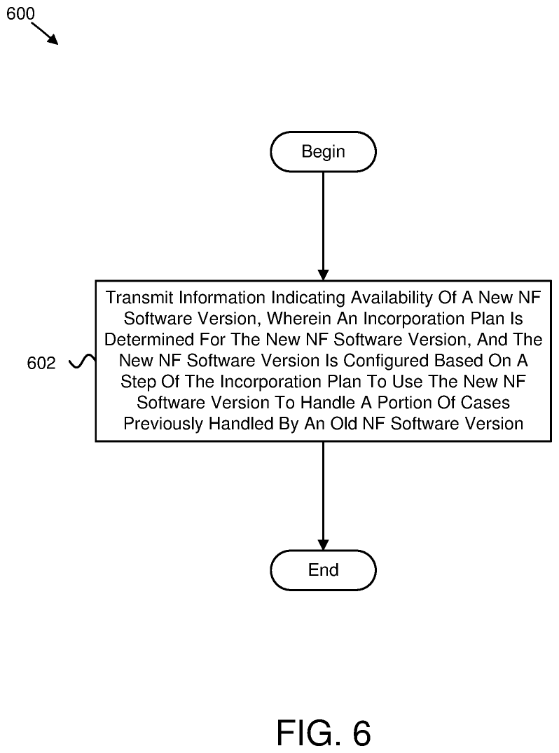

FIG. 6 is a flow chart diagram illustrating another embodiment of a method 600 for configuring a network function software version. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes transmitting 602, from a network device, information indicating availability of a new NF software version. An incorporation plan is determined for the new NF software version, and the new NF software version is configured based on a step of the incorporation plan to use the new NF software version to handle a portion of cases previously handled by an old NF software version.

In one embodiment, an apparatus comprises: a receiver to receive a new NF software version; and a processor to: determine an incorporation plan for the new NF software version; and configure the new NF software version based on a step of the incorporation plan to use the new NF software version to handle a portion of cases previously handled by an old NF software version.

In certain embodiments, the processor further to: compare operation of the new NF software version to a predetermined performance criterion; and in response to the new NF software version meeting the predetermined performance criterion, increase or decrease usage of the new NF software version based on a next step or a previous step of the incorporation plan.

In some embodiments, the processor to increase usage (e.g., assigning a larger portion of cases to use the new NF software version) of the new NF software version based on the next step of the incorporation plan comprises the processor to incrementally increase usage of the new NF software version until an old NF software version is no longer used.

In various embodiments, the processor further to, in response to the old NF software version no longer being used, initiate removal of the old NF software version.

In one embodiment, the processor further to, in response to the new NF software version meeting a predetermined underperformance criterion, decrease usage of the new NF software version based on the previous step of the incorporation plan.

In certain embodiments, the processor to decrease usage (e.g., assigning a smaller portion of cases to use the new NF software version) of the new NF software version based on the previous step of the incorporation plan comprises the processor further to incrementally decrease usage of the new NF software version until the new NF software version is no longer used.

In some embodiments, the processor further to monitor operation of the new NF software version and monitoring operation of the old NF software version.

In some embodiments, the predetermined performance criterion comprises a comparison of operation of the new NF software version to operation of the old NF software version.

In one embodiment, the portion of cases comprises UEs assigned to the new NF software version, subscription requests, service requests, notification requests, requests for any functionalities the NF may provide, or some combination thereof.

In certain embodiments, the cases or UEs are assigned to the new NF software version based on a location, a parameter, a characteristic, an event, a predetermined condition or some combination thereof.

In some embodiments, the processor further to determine whether to incorporate the new NF software version.

In one embodiment, a method at a network device comprises: receiving a new NF software version: determining an incorporation plan for the new NF software version; and configuring the new NF software version based on a step of the incorporation plan to use the new NF software version to handle a portion of cases previously handled by an old NF software version.

In certain embodiments, the method further comprises: comparing operation of the new NF software version to a predetermined performance criterion; and in response to the new NF software version meeting the predetermined performance criterion, increasing or decreasing usage of the new NF software version based on a next step or a previous step of the incorporation plan.

In some embodiments, increasing usage of the new NF software version based on the next step of the incorporation plan comprises incrementally increasing usage of the new NF software version until an old NF software version is no longer used.

In some embodiments, the method further comprises, in response to the old NF software version no longer being used, initiating removal of the old NF software version.

In one embodiment, the method further comprises, in response to the new NF software version meeting a predetermined underperformance criterion, decreasing usage of the new NF software version based on the previous step of the incorporation plan.

In certain embodiments, decreasing usage of the new NF software version based on the previous step of the incorporation plan comprises incrementally decreasing usage of the new NF software version until the new NF software version is no longer used.

In some embodiments, the method further comprises monitoring operation of the new NF software version and monitoring operation of the old NF software version.

In some embodiments, the predetermined performance criterion comprises a comparison of operation of the new NF software version to operation of the old NF software version.

In one embodiment, the portion of cases comprises UEs assigned to the new NF software version, subscription requests, service requests, notification requests, requests for any functionalities the NF may provide, or some combination thereof.

In certain embodiments, the cases or UEs are assigned to the new NF software version based on a location, a parameter, a characteristic, an event, a predetermined condition or some combination thereof.

In some embodiments, the method further comprises determining whether to incorporate the new NF software version.

In one embodiment, an apparatus comprises: a transmitter to transmit information indicating availability of a new NF software version, wherein an incorporation plan is determined for the new NF software version, and the new NF software version is configured based on a step of the incorporation plan to use the new NF software version to handle a portion of cases previously handled by an old NF software version.

In one embodiment, a method at a network device comprises: transmitting information indicating availability of a new NF software version, wherein an incorporation plan is determined for the new NF software version, and the new NF software version is configured based on a step of the incorporation plan to use the new NF software version to handle a portion of cases previously handled by an old NF software version.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a network function, the apparatus comprising:
at least one memory; and
at least one processor coupled with the at least one memory and configured to cause the apparatus to:
receive a new network function (NF) software version;
determine an incorporation plan for the new NF software version; and
configure the new NF software version based on a step of the incorporation plan to use the new NF software version to handle a portion of cases previously handled by an old NF software version.

2. The apparatus of claim 1, wherein the at least one processor is configured to cause the apparatus to:
compare operation of the new NF software version to a predetermined performance criterion; and
in response to the new NF software version meeting the predetermined performance criterion, increase or decrease usage of the new NF software version based on a next step or a previous step of the incorporation plan.

3. The apparatus of claim 2, wherein the at least one processor is configured to cause the apparatus to increase usage of the new NF software version based on a next step of the incorporation plan by incrementally increasing usage of the new NF software version until an old NF software version is no longer used.

4. The apparatus of claim 3, wherein the at least one processor is configured to cause the apparatus to, in response to the old NF software version no longer being used, initiate removal of the old NF software version.

5. The apparatus of claim 2, wherein the at least one processor is configured to cause the apparatus to, in response to the new NF software version meeting a predetermined underperformance criterion, decrease usage of the new NF software version based on the previous step of the incorporation plan.

6. The apparatus of claim 5, wherein the at least one processor is configured to cause the apparatus to decrease usage of the new NF software version based on the previous step of the incorporation plan by incrementally decreasing usage of the new NF software version until the new NF software version is no longer used.

7. The apparatus of claim 2, wherein the at least one processor is configured to cause the apparatus to monitor operation of the new NF software version and monitor operation of the old NF software version.

8. The apparatus of claim 7, wherein the predetermined performance criterion comprises a comparison of operation of the new NF software version to operation of the old NF software version.

9. The apparatus of claim 1, wherein the portion of cases comprises user equipments (UEs) assigned to the new NF software version, subscription requests, service requests, notification requests, requests for any functionalities the NF may provide, or a combination thereof.

10. The apparatus of claim 9, wherein the cases or UEs are assigned to the new NF software version based on a location, a parameter, a characteristic, an event, a predetermined condition or a combination thereof.

11. The apparatus of claim 1, wherein the at least one processor is configured to cause the apparatus to determine whether to incorporate the new NF software version.

12. A method of performing a network function, the method comprising:
receiving a new network function (NF) software version;
determining an incorporation plan for the new NF software version; and
configuring the new NF software version based on a step of the incorporation plan to use the new NF software version to handle a portion of cases previously handled by an old NF software version.

13. The method of claim 12, further comprising:
comparing operation of the new NF software version to a predetermined performance criterion; and
in response to the new NF software version meeting the predetermined performance criterion, increasing or decreasing usage of the new NF software version based on a next step or a previous step of the incorporation plan.

14. The method of claim 13, wherein increasing usage of the new NF software version based on a next step of the incorporation plan comprises incrementally increasing usage of the new NF software version until an old NF software version is no longer used.

15. An apparatus for performing a network function, the apparatus comprising:
at least one memory; and
at least one processor coupled with the at least one memory and configured to cause the apparatus to:
transmit information indicating availability of a new network function (NF) software version, wherein an incorporation plan is determined for the new NF software version, and the new NF software version is configured based on a step of the incorporation plan to use the new NF software version to handle a portion of cases previously handled by an old NF software version.

16. A method of performing a network function, the method comprising:
transmitting information indicating availability of a new network function (NF) software version, wherein an incorporation plan is determined for the new NF software version, and the new NF software version is configured based on a step of the incorporation plan to use the new NF software version to handle a portion of cases previously handled by an old NF software version.

17. The method of claim 12, further comprising:
comparing operation of the new NF software version to a predetermined performance criterion; and
in response to the new NF software version meeting the predetermined performance criterion, increasing or decreasing usage of the new NF software version based on a next step or a previous step of the incorporation plan.

18. The method of claim 17, further comprising increasing usage of the new NF software version based on a next step of the incorporation plan by incrementally increasing usage of the new NF software version until an old NF software version is no longer used.

19. The method of claim 18, further comprising, in response to the old NF software version no longer being used, initiating removal of the old NF software version.

20. The method of claim 17, further comprising, in response to the new NF software version meeting a predetermined underperformance criterion, decreasing usage of the new NF software version based on the previous step of the incorporation plan.
